(19) United States
(12) Patent Application Publication
(10) Pub. No.: US 2013/0280619 A1
(43) Pub. Date: Oct. 24, 2013

(54) Solid Type Secondary Battery Using Silicon Compound and Method for Manufacturing the Same

(71) Applicants: Shoji Ichimura, Shizuoka (JP); Fukuyo Ichimura, Shizuoka (JP)

(72) Inventors: Shoji Ichimura, Shizuoka (JP); Fukuyo Ichimura, Shizuoka (JP)

(21) Appl. No.: 13/577,111

(22) PCT Filed: Aug. 15, 2011
(86) PCT No.: PCT/JP2011/068500

§ 371 Date: Aug. 3, 2012

(30) Foreign Application Priority Data
Dec. 22, 2010 (JP) 2010-285293

(51) Int. Cl. H01M 10/0565; H01M 10/058

(52) U.S. Cl. CPC H01M 10/0565; H01M 10/058
USPC 429/314; 429/188; 429/306; 429/317; 29/623.5

(57) ABSTRACT

A solid type secondary battery manufactured at low cost and which rarely causes an environmental problem by employing a silicon compound in a positive electrode and a negative electrode, includes silicon carbide having a chemical formula Si₂C in a negative electrode 5, silicon nitride having a chemical formula of Si₂N₃ in a positive electrode 3 and a cationic or anionic nonaqueous electrolyte 4 between the positive electrode 3 and the negative electrode 5.

### FIELD OF THE INVENTION

The present invention relates to a solid type secondary battery employing a silicon compound in a positive electrode and a negative electrode and a nonaqueous electrolyte between the two electrodes, and a method for manufacturing the same.

### BACKGROUND OF THE INVENTION

Recently, with the spread of portable machines such as personal computers and mobile phones, demand for a secondary battery serving as a power source for the machines has been rapidly increasing.

A typical example of such a secondary battery is a lithium battery, which uses lithium (Li) in a negative electrode and e.g., a β-manganese oxide (MnO₂) or fluorocarbon ((CF)ₙ) in a positive electrode.

In particular, recently, extraction (flow out) of metal lithium can be prevented by interposing a nonaqueous electrolyte between a positive electrode and a negative electrode, causing wide spread of lithium batteries.

However, lithium is quite expensive. Besides, when a lithium battery is finally disposed, metal lithium flows out at a disposal site. This is inevitably and extremely unfavorable situation for the environment.

In contrast, when silicon (Si), which is intrinsically a semiconductor, is used as a material for an electrode, Si is extraordinary inexpensive compared to lithium and even if a battery is finally disposed, silicon is buried in the ground and causes no environmental problems such as metal-lithium flow out.

Taking into account the circumstances, recently, attempts have been made to employ silicon as an electrode material for a secondary battery.

Note that, Japanese Patent Laid-Open No. 11-007979 employs, as a negative electrode, a metal silicon compound (SiMx: x1>0, where M represents one or more metal elements including lithium, nickel, iron, cobalt, manganese, calcium and magnesium) (claim 1).

Similarly, also in Japanese Patent Laid-Open No. 2001-291513, as a negative electrode, an alloy of cobalt or nickel and iron (Co or Ni—Si) is employed (Examples, Table 1).

However, in these conventional techniques, silicon is not employed in a positive electrode and a negative electrode but its alloy with a metal is employed. After all, an increase in material cost cannot be avoided.

In such circumstances, the present applicant proposed, in Japanese Patent Application No. 2010-168403, a constitution of a solid type secondary battery employing silicon carbide having a chemical formula of SiC as a positive electrode and silicon nitride having a chemical formula of Si₃N₄ as a negative electrode, in which a silicon cation (Si⁺) is generated at the positive electrode and a silicon anion (Si⁻) is generated at the negative electrode during charging (hereinafter, the invention of the solid type secondary battery will be simply referred to as the “prior invention”).

The solid type secondary battery can ensure an electromotive force virtually comparable to that of a so-called lithium battery even at a low cost, and furthermore, can preferably employ both cationic and anionic nonaqueous electrolytes. In these respects, the solid type secondary battery has epoch-making significance.

However, the constitution employing silicon nitride and silicon carbide as electrodes is not limited to the prior invention.

### PATENT LITERATURE

PATENT LITERATURE 1: Publication of Unexamined Patent Application No. H 11-007979

PATENT LITERATURE 2: Publication of Unexamined Patent Application No. 2001-291513

### SUMMARY OF THE INVENTION

### Problems to be Solved by the Invention

As with the prior invention, an object of the present invention is to provide a constitution of a solid type secondary battery employing a silicon compound in a positive electrode and a negative electrode, manufactured at low cost and rarely causing environmental problems, and to provide a process for manufacturing the same.

### Solutions to Problems

Basic constitutions of the present invention to attain the aforementioned object are as follows:

1. A solid type secondary battery comprising silicon nitride having a chemical formula of Si₂N₃ as a positive electrode, silicon carbide having a chemical formula of Si₂C as a negative electrode, and a nonaqueous electrolyte, between the positive electrode and the negative electrode, formed of any one of ion exchange resins of polymers having a cationic sulfonic acid group (—SO₃H) or carboxyl group (—COOH), or an anionic quaternary ammonium group (—N(CH₃)₂C₂H₄OH) or substituted amino group (—NH(CH₃)₂) as a binding group, in which, in discharging, at the negative electrode, a silicon cation (Si⁺) and an electron (e⁻) are released; and, at the positive electrode, a nitrogen molecule (N₂) and an oxygen molecule (O₂) in the air chemically bond to the silicon nitride (Si₂N₃) and the silicon cation (Si₋⁺) and the electron (e⁻) transferred from the negative electrode; whereas, in charging, at the negative electrode, a silicon cation (Si⁺) and an electron (e⁻) are absorbed; and, at the positive electrode, the chemical bond between a nitrogen molecule and an oxygen molecule are broken and the nitrogen molecule and oxygen molecule are released into the air;

2. A solid type secondary battery comprising silicon nitride having a chemical formula of Si₂N₃ as a positive electrode, silicon carbide having a chemical formula of Si₂C as a negative electrode, and a nonaqueous electrolyte, between the positive electrode and the negative electrode, formed of an inorganic ion exchange substance of tin chloride (SnCl₃), zirconium magnesium oxide solid solution (ZrMgO₃), zirconium calcium oxide solid solution (ZrCaO₃), zirconium oxide (ZrO₂), silicon-βalumina (Al₂O₃), monoxide nitrogen silicon carbide (SiCON) or phosphoric acid zirconium silicon (Si₂Zr₂PO), in which, in discharging, at the negative electrode, a silicon cation (Si⁺) and an electron (e⁻) are released; and, at the positive electrode, a nitrogen molecule (N₂) and an oxygen molecule (O₂) in the air chemically bond to the silicon nitride (Si₂N₃) and the silicon cation (Si⁺) and the electron (e⁻) transferred from the negative electrode; whereas, in charging, at the negative electrode, a silicon cation (Si⁺) and an electron (e⁻) are absorbed; and, at the positive electrode, the chemical bond between a nitrogen molecule and an oxygen molecule are broken and the nitrogen molecule and oxygen molecule are released into the air; and

3. A method for manufacturing the solid type secondary battery described in one of claim 1 or 2, comprising the steps of:
(1) forming a positive electrode current collecting layer by sputtering a metal on a substrate,
(2) forming a positive electrode layer by vacuum vapor deposition of silicon nitride (Si₂N₃) on the positive electrode current collecting layer,
(3) forming a nonaqueous electrolyte layer by coating of the positive electrode layer obtained in said step (2),
(4) forming a negative electrode layer by vacuum vapor deposition of silicon carbide (Si₂C) on the nonaqueous electrolyte layer obtained in said step (3), and
(5) forming a negative electrode current collecting layer by sputtering a metal.

### ADVANTAGES OF THE INVENTION

The secondary battery of the present invention according to any one of the basic constitutions of the aforementioned inventions as claimed in claims 1, 2 and 3 provides an electromotive force virtually comparable to that of a secondary battery using lithium as a negative electrode, at a low cost. Besides, even if the secondary battery is disposed, environmental problems do not occur, unlike a lithium battery.

In addition, discharge characteristics and charge characteristics slightly exceeding those of the prior invention can be presented.

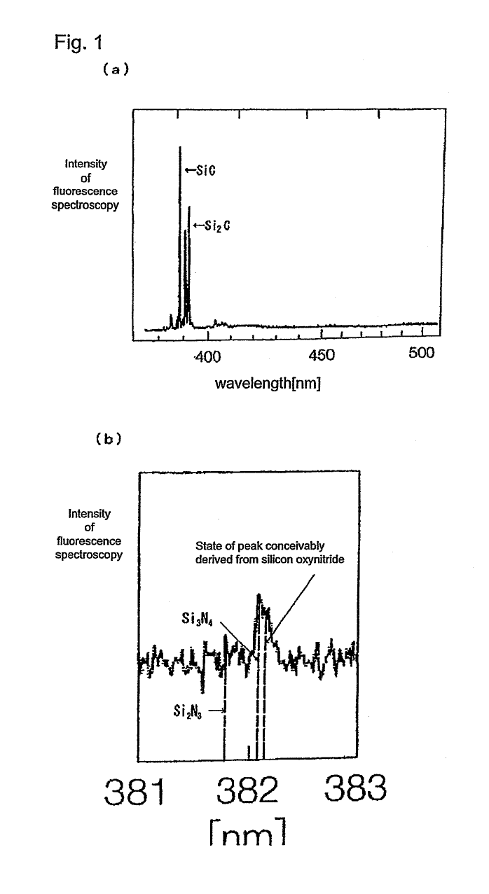

### BRIEF DESCRIPTION OF THE DRAWINGS

[FIG. 1]

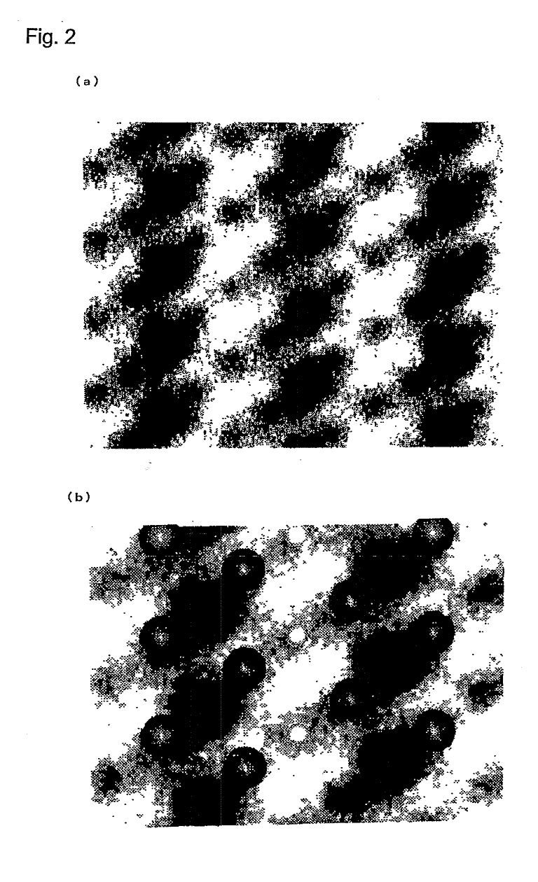

The figure shows the spectroscopic analysis results based on fluorescence spectroscopy in discharging, where (a) shows the case of a negative electrode; whereas (b) shows the case of a positive electrode.

[FIG. 2]

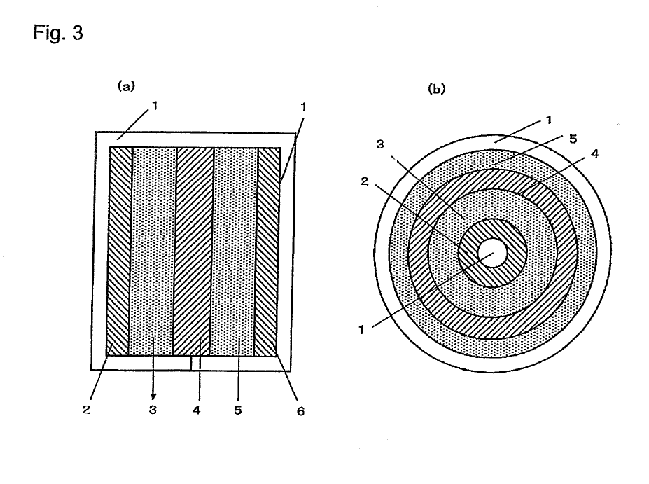

The figure shows electron micrographs (magnification: 200,000×) of the surface of a negative electrode in the stages of completion of discharge and charge operations, where (a) shows a case of discharging; whereas (b) shows a case of charging.

[FIG. 3]

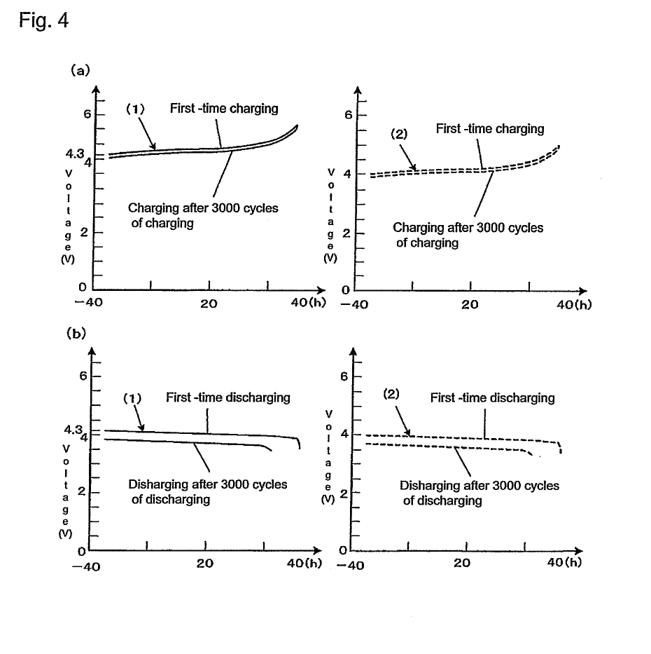

The figure shows sectional views of solid type secondary batteries of the present invention, in which (a) shows a plate-form laminate and (b) shows a cylindrical laminate.

[FIG. 4]

The figure is a graph showing charge-discharge varied with time and further showing a change in voltage after a charge-discharge cycle is repeated 3000 times in Example, in comparison with those of the prior invention, where (a) shows a state of charging; whereas (b) shows a state of discharging.

### DETAILED DESCRIPTION OF THE INVENTION

In the first place, a basic principle of the present invention will be described.

Generally, the chemical formula of the most stable silicon carbide is SiC and the chemical formula of the most stable silicon nitride is Si₃N₄.

Accordingly, a compound Si₂C constituting a negative electrode and Si₂N₃ constituting a positive electrode are not always stable. Thus, in discharging, it is naturally predicted that they are formed into SiC and Si₃N₄, respectively.

Actually, a spectrograph (based on fluorescence spectroscopy) of a negative electrode when discharge was performed is shown in FIG. 1 (a). According to the spectrograph, the highest peak showing a compound (SiC) is observed at a position of about 388 nm and the next highest peak showing a compound (Si₂C) is observed at a position of about 392 nm.

According to the state, in discharging at a negative electrode, the following chemical reaction takes place.

Si₂C→SiC+Si⁺e⁻

Conversely, in charging at a negative electrode, the following chemical reaction takes place.

SiC+Si⁺+e⁻→Si₂C

To form the most stable compound (Si₃N₄) by discharging at a positive electrode, nitrogen in the air is inevitably involved in the chemical reaction. Conversely, in charging, nitrogen involved in formation of the compound (Si₃N₄) is inevitably released into the air.

However, as is in FIG. 2 (a), (b) showing photographs of magnified images (magnification: 200,000×), which were taken at a negative electrode 5 by an electron microscope at the time discharge and charge were completed, in the surface of a positive electrode 3 at the time charging was completed (as shown in FIG. 2 (b)), regular arrangement of not only precipitations derived from nitrogen molecules (array of black spheres) but also precipitations derived from oxygen molecules (array of white spheres), which are present in a ½ molar ratio to nitrogen molecules, can be observed.

Accordingly, in discharging, it is inevitably interpreted that not only nitrogen (N₂) in the air is involved in a chemical reaction but also oxygen (O₂) is involved in the reaction in a molar ratio of ½.

Generally, as the most stable silicon oxynitride, a compound (Si₂N₂O) is known. This compound is also present as a naturally-occurring product (for example, “Silicon nitride based ceramic new material”, 1st edition, edited by Yohtaro Matsuo and four others and published by Uchida Rokakuho Publishing Co., Ltd., on Oct. 30, 2009).

In consideration of the existence of such a silicon oxynitride compound (Si₂N₂O), in discharging at the positive electrode 3, the following chemical reaction is presumable.

Si₂N₃+2Si⁺+N₂+¼O₂+2e⁻→½Si₂N₂O+Si₃N₄

Conversely, in charging at the positive electrode 3, the following chemical reaction is presumable.

½Si₂N₂O+Si₃N₄→Si₂N₃+2Si⁺+N₂+¼O₂+2e⁻

Actually, according to FIG. 1 (b) showing a crystal spectrum based on fluorescence spectroscopy in charging, the value of a peak showing Si₃N₄ at a position of about 382.1 nm can be confirmed and the value of a peak showing Si₂N₃ at a position of about 381.7 nm can be confirmed; at the same time, the peak observed at a position of 382.2 nm on the left side of the peak of Si₃N₄ presumably shows the peak value of a nitride oxide compound (Si₂N₂O) (Note that, determination cannot be clearly made on this point because data of fluorescence spectroscopy on a compound (Si₂N₂O) have not yet been accumulated).

Accordingly, if charge and discharge are integrated, the following chemical reaction is presumable:

Si₂N₃+2Si₂C+N₂+¼O₂⇄2SiC+½Si₂N₂O+Si₃N₄

Note that, the above general reaction formula can be estimated with extremely high probability; however, a possibility cannot be denied that reaction formulas may be present based on other charge/discharge mechanisms. Accordingly, accurate determination is left to future investigation.

Usually, the compound represented by Si₂N₃ and the compound represented by Si₂C both present a crystal structure. If a positive electrode and a negative electrode are formed respectively by a conventional process using e.g., plasma discharge, silicon nitride (compound represented by Si₂N₃) having a crystal structure and silicon carbide (compound represented by Si₂C) having a crystal structure come to be formed.

However, at the time of discharging, in order to smoothly release silicon ions (Si⁺) of silicon carbide (Si₂C) and electrons (e⁻) at a negative electrode and carry out the reaction between nitrogen such as silicon nitride (Si₂N₃) and oxygen (O₂) in the air at a positive electrode, it is preferable that each of the compounds described above has not a crystal structure but a non-crystalline structure, that is, an amorphous structure.

Therefore, as described later, a method of laminating a positive electrode and a negative electrode by vacuum vapor deposition is preferably employed.

As the electrolyte of the present invention, a nonaqueous electrolyte is employed in an immobilized state. This is because, the nonaqueous electrolyte in an immobilized state can join the positive electrode and the negative electrode in a stable state; at the same time, if the nonaqueous electrolyte is formed in the form of thin film, the positive electrode and the negative electrode are brought into close contact with each other, enabling efficient electric conduction.

As the nonaqueous electrolyte, both an ion exchange resin in the form of a polymer and an ion exchange inorganic compound in the form of a metal oxide can be employed.

As the ion exchange resin, any one of the polymers having a cationic sulfonic acid group (—SO₃H) or carboxyl group (—COOH), an anionic quaternary ammonium group (—N (CH₃)₂C₂H₄OH) or substituted amino group (—NH (CH₃)₂), as a binding group, can be employed.

Note that, according to experience of the inventors, polyacrylamidomethylpropane sulfonic acid (PAMPS) having a sulfonic acid group (—SO₃H) can be preferably employed since it can smoothly transfer silicon negative ions (Si⁻) without difficulty.

However, when an ion exchange resin in the form of a polymer is employed, if the space between the positive electrode and the negative electrode is filled with the ion exchange resin alone, appropriate voids for smoothly transferring silicon ions (Si⁺) sometimes cannot be formed.

To deal with such a case, an embodiment of employing a polymer alloy having a crystal structure, which is formed by blending an ion exchange resin (polymer) and another crystalline polymer, as a nonaqueous electrolyte, is preferably employed.

To successfully blend an ion exchange resin (polymer) and another crystalline polymer, since the ion exchange resin has a polarity, a measure must be taken not to diminish the polarity of the ion exchange resin (polymer) by the crystalline polymer.

In blending of polymers as mentioned above, the propriety of the blending can be predicted with an adequate provability, based on a difference between solubility parameters (SP value) that the ion exchange resin (polymer) and the crystalline polymer respectively have as well as numerical values of χ parameter based on the binding of the solubility parameters.

As “another crystalline polymer”, e.g., atactic polystyrene (AA), an acrylonitrile-styrene copolymer (AS) or an atactic polystyrene-acrylonitrile-styrene copolymer (AA-AS) is preferable since it is easily blended with an ion exchange resin (polymer) and maintains crystallinity.

For a polymer alloy, in which two polymers are mutually blended, to maintain a crystal structure, it is necessary to consider the amount ratio of the ion exchange resin (polymer) and another crystalline polymer. A specific ratio (numerical value) varies depending upon the types of ion exchange resin (polymer) and another crystalline polymer.

However, when the polarity of the ion exchange resin (polymer) is high, the weight ratio of “another crystalline polymer” can be increased to more than ½ of the total.

When cationic polyacrylamidomethylpropane sulfonic acid (PAMPS) is employed as a cationic ion exchange resin (polymer), and an atactic polystyrene (AA), an acrylonitrile-styrene copolymer (AS) or an atactic polystyrene-acrylonitrile-styrene copolymer (AA-AS) as described above is employed as “another crystalline polymer”, the weight ratio of the former one to the latter one is appropriately about 2:3 to 1:2.

The nonaqueous electrolyte is not limited to ion exchange resins mentioned above. Of course, an inorganic ion exchange substance can be employed. Typical examples thereof may include tin chloride (SnCl₃), zirconium magnesium oxide solid solution (ZrMgO₃), zirconium calcium oxide solid solution (ZrCaO₃), zirconium oxide (ZrO₂), silicon-βalumina (Al₂O₃), monoxide nitrogen silicon carbide (SiCON) and phosphoric acid zirconium silicon (Si₂Zr₂PO).

In the solid type secondary battery of the present invention, the shape and arrangement of the positive electrode and the negative electrode are not particularly limited.

However, as a typical example, plate-form laminate arrangement as shown in FIG. 3 (a) and cylindrical arrangement as shown in FIG. 3 (b) can be employed.

As shown in FIG. 3 (a), (b), in a solid type secondary battery actually used, a substrate 1 is provided on the both sides of a positive electrode 3 and a negative electrode 5 and connected to the positive electrode 3 and the negative electrode 5 respectively with a positive electrode current collecting layer 2 and a negative electrode current collecting layer 6 interposed between them.

The discharge voltage between the cathode and the anode varies depending upon the magnitude of charging voltage and the internal resistance within the electrodes. In the secondary battery of the present invention, as described in Example later, design can be sufficiently made such that if a charging voltage is set to 4 to 5.5 V, a discharge voltage can be maintained at 4 to 3.5 V.

The amount of current flowing between the electrodes can be set at a predetermined value in advance before charging; however, as described later in Example, design can be sufficiently made such that a charging voltage is changed to 4 to 5.5 V and a discharge voltage can be maintained at 4 to 3.5 V by setting the current density per unit area (1 cm²) to about 1.0 A.

A method for manufacturing solid type secondary batteries as shown in FIG. 3 (a), (b) is as follows.

(1) Formation of positive electrode current collecting layer 2

On the substrate 1, a metal powder is deposited by sputtering to form the positive electrode current collecting layer 2.

As a typical example of substrate 1, quartz glass is preferably employed. As the metal, a precious metal such as platinum is frequently used.

(2) Formation of positive electrode active layer

In the state where the peripheral portion of the positive electrode current collecting layer 2 is masked, silicon nitride (Si₂N₃) is laminated by vacuum vapor deposition.

(3) Formation of nonaqueous electrolyte layer 4 To the positive electrode active layer, a nonaqueous electrolyte layer 4 is formed by coating to laminate the electrolyte layer.

(4) Formation of negative electrode active layer

In the state where the peripheral portion of the nonaqueous electrolyte layer 4 is masked, silicon carbide (Si₂C) is laminated on the nonaqueous electrolyte layer 4 by vacuum vapor deposition.

(5) Formation of negative electrode current collecting layer 6

The periphery of the negative electrode current collecting layer 6 and the electrolyte layer are masked and a metal powder is deposited by sputtering to laminate the negative electrode current collecting layer 6.

The negative electrode current collecting layer 6 is often formed by using platinum (Pt).

Needless to say, the order of steps (1) and (5) may be exchanged and the order of steps (2) and (4) may be exchanged to first form the structure on the side of the negative electrode 5 and then the structure on the side of the positive electrode 3 is formed. Such manufacturing steps can be employed.

In the steps (1) to (5), when a flat-plate laminate structure is employed, a full solid silicon secondary battery can be formed of a plate laminate as shown in FIG. 3 (a).

In contrast, in the above steps, when a cylindrical laminate structure is formed on a cylindrical substrate 1, a full solid silicon secondary battery can be formed of a cylindrical laminate as shown in FIG. 3 (b).

### EMBODIMENT

A solid type secondary battery of a plate-form laminate as shown in FIG. 3 (a) was manufactured by providing a positive electrode 3 and a negative electrode 5 having a thickness of 150 μm and a diameter of 20 mm and providing a nonaqueous electrolyte layer 4 of 100 μm thick, which was obtained by mutually blending a polyacrylamidomethylpropane sulfonic acid (PAMPS)(polymer) and another crystalline polymer such as atactic polystyrene (AA), acrylonitrile-styrene copolymer (AS) or an atactic polystyrene-acrylonitrile-styrene copolymer (AA-AS), in a weight ratio of 1:1. In this way, a solid type silicon secondary battery of the present invention was manufactured.

The secondary battery obtained above was charged from a regular current source so as to obtain a current density of 1.0 ampere per area (cm²). As a result, a charging voltage was successfully maintained within the range of 4.3 V to 5.5 V for about 40 hours, as indicated by the upper liner of FIG. 4 (a) (1).

When the operation was switched from the charging process to a discharge process, a discharge state of 4.3 V to 3.8 V was successfully maintained for about 35 hours, as indicated by the upper liner of FIG. 4 (b) (1).

The charge voltage and discharge voltage after the charge and discharge cycle was repeated 3000 times changed as indicated by the lower lines of FIGS. 4 (a) (1) and 4 (b) (1), respectively. It was found that each of the voltages does not decrease at all and furthermore, discharge time only decreases at most by about 5 hours.

In short, it was demonstrated by such a cycle test that the life of the solid type secondary battery of the present invention is extremely long.

Note that, in FIG. 4 (a) (2), the lines show changes in voltage in initial charging and after 3000 cycles of charging, respectively, in the prior invention. In FIG. 4 (b) (2), the lines show a change in voltage in initial discharging and after 3000 cycles of discharging, respectively in the prior invention. It is found that charge voltage and discharge voltage of the present invention are slightly higher than those of the prior invention.

### INDUSTRIAL APPLICABILITY

In the solid secondary battery of the present invention, if the size and shape of the positive electrode and negative electrode are modified in various ways, it is sufficiently possible that the discharge time is greatly improved than the design shown in Example. If so, the solid secondary battery can be sufficiently used as a power source for e.g., personal computers and mobile phones.

### DESCRIPTION OF SYMBOLS

1 Substrate
2 Positive electrode current collecting layer
3 Positive electrode
4 Nonaqueous electrolyte
5 Negative electrode
6 Negative electrode current collecting layer

What is claimed is:

1. A solid type secondary battery comprising:
silicon nitride having a chemical formula of Si₂N₃ as a positive electrode,
silicon carbide having a chemical formula of Si₂C as a negative electrode, and
a nonaqueous electrolyte, between the positive electrode and the negative electrode, formed of any one of ion exchange resins of polymers selected from the group consisting of a cationic sulfonic acid group (—SO₃H), carboxyl group (—COOH), an anionic quaternary ammonium group (—N(CH₃)₂C₂H₄OH) and a substituted amino group (—NH(CH₃)₂) as a binding group,
wherein, in discharging, at the negative electrode, a silicon cation (Si⁺) and an electron (e⁻) are released; and, at the positive electrode, a nitrogen molecule (N₂) and an oxygen molecule (O₂) in the air are chemically bond bonded to the silicon nitride (Si₂N₃) and the silicon cation (Si⁺) and the electron (e⁻) transferred from the negative electrode;
whereas, in charging, at the negative electrode, a silicon cation (Si⁺) and an electron (e⁻) are absorbed; and, at the positive electrode, the chemical bond between a nitrogen molecule and an oxygen molecule are broken and the nitrogen molecule and oxygen molecule are released into the air.

2. A solid type secondary battery comprising:
silicon nitride having a chemical formula of Si₂N₃ as a positive electrode,
silicon carbide having a chemical formula of Si₂C as a negative electrode, and
a nonaqueous electrolyte, between the positive electrode and the negative electrode, formed of an inorganic ion exchange substance selected from the group consisting of tin chloride (SnCl₃), zirconium magnesium oxide solid solution (ZrMgO₃), zirconium calcium oxide solid solution (ZrCaO₃), zirconium oxide (ZrO₂), silicon-balumina (Al₂O₃), monoxide nitrogen silicon carbide (SiCON) and phosphoric acid zirconium silicon(Si₂Zr₂PO),
wherein, in discharging, at the negative electrode, a silicon cation (Si⁺) and an electron (e⁻) are released; and, at the positive electrode, a nitrogen molecule (N₂) and an oxygen molecule (O₂) in the air are chemically bonded to the silicon nitride (Si₂N₃) and the silicon cation (Si⁺) and the electron (e⁻) transferred from the negative electrode;
whereas, in charging, at the negative electrode, a silicon cation (Si⁺) and an electron (e⁻) are absorbed; and, at the positive electrode, the chemical bond between a nitrogen molecule and an oxygen molecule are broken and the nitrogen molecule and oxygen molecule are released into the air.

3. The solid type secondary battery according to claim 1, wherein silicon nitride and silicon carbide formed into an amorphous film are laminated on a substrate.

4. The solid type secondary battery according to claim 1, wherein polyacrylamidomethylpropane sulfonic acid (PAMPS) is employed as the ion exchange resin.

5. The solid type secondary battery according to claim 1, wherein, a polymer alloy having a crystal structure and formed by blending one said ion exchange resin of a polymer and another crystalline polymer is employed as the nonaqueous electrolyte.

6. The solid type secondary battery according to claim 5, wherein a material selected from the group consisting of atactic polystyrene (AA), acrylonitrile-styrene copolymer (AS) and atactic polystyrene-acrylonitrile-styrene copolymer (AA-AS) is employed as the crystalline polymer.

7. A method for manufacturing the solid type secondary battery according to claim 1, the method comprising the steps of:
(1) forming a positive electrode current collecting layer by sputtering a metal on a substrate,
(2) forming a positive electrode layer by vacuum vapor deposition of silicon nitride (Si₂N₃) on the positive electrode current collecting layer,
(3) forming a nonaqueous electrolyte layer by coating of the positive electrode layer obtained in said step (2),
(4) forming a negative electrode layer by vacuum vapor deposition of silicon carbide (Si₂C) on the nonaqueous electrolyte layer obtained in said step (3), and
(5) forming a negative electrode current collecting layer by sputtering a metal.

8. The solid type secondary battery according to claim 2, wherein silicon nitride and silicon carbide formed into an amorphous film are laminated on a substrate.

9. Amended) The solid type secondary battery according to claim 4, wherein, a polymer alloy having a crystal structure and formed by blending one said ion exchange resin of a polymer and another crystalline polymer is employed as the nonaqueous electrolyte.

10. A method for manufacturing the solid type secondary battery according to claim 2, the method comprising the steps of:
(1) forming a positive electrode current collecting layer by sputtering a metal on a substrate,
(2) forming a positive electrode layer by vacuum vapor deposition of silicon nitride (Si₂N₃) on the positive electrode current collecting layer,
(3) forming a nonaqueous electrolyte layer by coating of the positive electrode layer obtained in said step (2),
(4) forming a negative electrode layer by vacuum vapor deposition of silicon carbide (Si₂C) on the nonaqueous electrolyte layer obtained in said step (3), and
(5) forming a negative electrode current collecting layer by sputtering a metal.
